(19) United States
(12) Patent Application Publication
(10) Pub. No.: US 2016/0209532 A1
(43) Pub. Date: Jul. 21, 2016

(54) APPLIED INTERPOLATION TECHNIQUES

(71) Applicant: Board of Regents, The University of Texas System, Austin, TX (US)

(72) Inventors: Maria C. Mariani, El Paso, TX (US); Kanadpriya Basu, Los Angeles, CA (US)

(73) Assignee: Board of Regents, The University of Texas System

(21) Appl. No.: 14/942,320

(22) Filed: Nov. 16, 2015

Related U.S. Application Data
(60) Provisional application No. 62/080,487, filed on Nov. 17, 2014.
(60) Provisional application No. 62/138,053, filed on Mar. 25, 2015.
(60) Provisional application No. 62/138,016, filed on Mar. 25, 2015.

(51) Int. Cl. G01V 1/30; G06Q 40/06; G06Q 10/06; G01V 1/28

(52) U.S. Cl. CPC G01V 1/307; G01V 1/282; G06Q 40/06; G06Q 10/067

(57) ABSTRACT

Methods and systems for processing data such as geophysical data or financial data to estimate an outcome. Such data can be received as input. Then, spatial analysis can be performed with respect to the data by applying varying interpolation techniques to the data. An interpolation surface can then be generated as output in response to performing the spatial analysis with respect to the data, wherein the interpolation surface is utilized for estimating in the case of geophysical data, earthquake magnitude data for a particular location on a later date, assuming an earthquake trend remains constant at the particular location. In the case of financial data, the likelihood of a financial market crash can be determined.

### CROSS-REFERENCE TO PROVISIONAL APPLICATION

This application claims priority under 35 U.S.C. 119(e) to U.S. Provisional Patent Application Ser. No. 62/080,487, entitled “Applied Interpolation Techniques,” which was filed on Nov. 17, 2014, the disclosure of which is incorporated herein by reference in its entirety. This application also claim priority under 35 U.S.C. 119(e) to U.S. Provisional Patent Application Ser. No. 62/138,053, entitled “Stochastic Models Applied to Seismic Data,” which was filed on Mar. 25, 2015, the disclosure of which is incorporated herein by reference in its entirety. The application further claims priority under 35 U.S.C. 119(e) to U.S. Provisional Patent Application Ser. No. 62/138,016, entitled “Method and Apparatus for Analyzing Ground-Related Data,” which was filed on Mar. 25, 2015, the disclosure of which is incorporated herein by reference in its entirety.

### TECHNICAL FIELD

Embodiments are related to interpolation techniques and the processing of information such as, for example, geophysical data and financial data. Embodiments also relate to the field of earthquake prediction, specifically the estimation of earthquake magnitude data from geophysical data. Embodiments also relate to the field of financial market prediction.

### BACKGROUND

In numerical analysis, interpolation involves a process for estimating values that lie within the range of a known discrete set of data points. In engineering and science, one often has a number of data points, obtained by sampling or experimentation, which represent the values of a function for a limited number of values of the independent variable. It is often required to interpolate (i.e., estimate) the function at an intermediate value of the independent variable. This may be achieved by curve fitting or regression analysis.

Another similar problem involves approximating complicated functions by employing simple functions. Suppose a formula is known for evaluating a function, but is too complex to calculate at a given data point. A few known data points from the original function may be utilized to create an interpolation based on a simpler function. Of course, when a simple function is employed to estimate data points from the original, interpolation errors are usually present. Depending on the problem domain and the interpolation method that was used, however, the gain in simplicity may be of greater value than the resultant loss in accuracy. There is also another type of interpolation in mathematics referred to as “Interpolation of Operators”.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for improved interpolation techniques.

It is another aspect of the disclosed embodiments to provide for improved interpolation techniques used in the processing of data, such as, for example, geophysical data and financial data.

It is yet another aspect of the disclosed embodiments to provide for the estimation of earthquake magnitude data from geophysical data.

It is also an aspect of the disclosed embodiments to provide for the use of deterministic models applied to spatial earthquake data and financial data for respective estimations of earthquake magnitudes and financial market crashes.

The aforementioned aspects and other objectives and advantages can now be achieved as described herein. Applied interpolation techniques are disclosed including methods and systems for processing data such as geophysical data or financial data, and estimating an outcome. Such data can be received as input. Then, spatial analysis can be performed with respect to the data by applying varying interpolation techniques to the data. An interpolation surface can then be generated as output, in response to performing the spatial analysis with respect to the data, wherein the interpolation surface is utilized for estimating in the case of geophysical data, earthquake magnitude data for a particular location on a later date, assuming an earthquake trend remains constant at the particular location. In the case of financial data, the likelihood of a financial market crash can be determined

In another embodiment, two deterministic models can be applied to spatial earthquake data. In other embodiments, a modified version of the aforementioned model(s) can be applied to analyzing financial data to determine, for example, the likelihood of a financial market crash.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of a computer system, which can be implemented in accordance with an embodiment;

FIG. 2 illustrates a schematic view of a software system including a module, an operating system, and a user interface, which can be implemented in accordance with an embodiment;

FIG. 3A illustrates a graph labeled “Real Data” and a graph labeled “Z vs x,y” that together depict data indicative of simulation results for an earthquake, in accordance with an example embodiment;

FIG. 3B illustrates a graph labeled “Real Data” and a graph also labeled “Real Data” that together depict data indicative of simulation results for an earthquake, in accordance with an example embodiment;

FIG. 3C illustrates a graph labeled “Real Data” that depicts data indicative of simulation results for an earthquake, in accordance with an example embodiment;

FIG. 4A illustrates a graph labeled “Real Data” depicting group of graphs depicting data indicative of simulation results for an earthquake, in accordance with an example embodiment;

FIG. 4B illustrates a graph labeled “z vs. x, y” above a graph labeled “Real Data” that together depict data indicative of simulation results for an earthquake, in accordance with an example embodiment;

FIG. 4C illustrates a graph labeled “Real Data” above another graph labeled “Real Data” that together depict data indicative of simulation results for earthquake, in accordance with an example embodiment;

FIG. 5A illustrates a graph labeled “Real Data” above another graph also labeled “Real Data” that together depicts data indicative of simulation results for an earthquake, in accordance with an example embodiment;

FIG. 5B illustrates a graph labeled “Real Data” above another graph labeled “Real Data” that together depict data indicative of simulation results for an earthquake, in accordance with an example embodiment;

FIG. 5C illustrates a graph labeled “Real Data” that depicts data indicative of simulation results for an earthquake, in accordance with an example embodiment;

FIG. 6A illustrates a graph depicting data indicative of simulation results for an earthquake, in accordance with an example embodiment;

FIG. 6B illustrates a graph labeled “Real Data” above another graph labeled “Real Data” that together depict data indicative of simulation results for an earthquake, in accordance with an example embodiment;

FIG. 6C illustrates a graph labeled “Real Data” above another graph labeled “Real Data” that together depict data indicative of simulation results for an earthquake, in accordance with an example embodiment;

FIG. 7A illustrates a graph labeled “Real Data” above another graph labeled “Real Data” that together depict data indicative of simulation results for an earthquake, in accordance with an example embodiment;

FIG. 7B illustrates a graph labeled “Real Data” above another graph labeled “Real Data” that together depict data indicative of simulation results for an earthquake, in accordance with an example embodiment;

FIG. 7C illustrates a graph labeled “Real Data” that depicts data indicative of simulation results for an earthquake, in accordance with an example embodiment; and

FIG. 8 illustrates a high-level flow chart of operations illustrating a method for processing data such as geophysical data or financial data, in accordance with an example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As can be appreciated by one skilled in the art, embodiments can be implemented in the context of a method, data processing system, and/or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

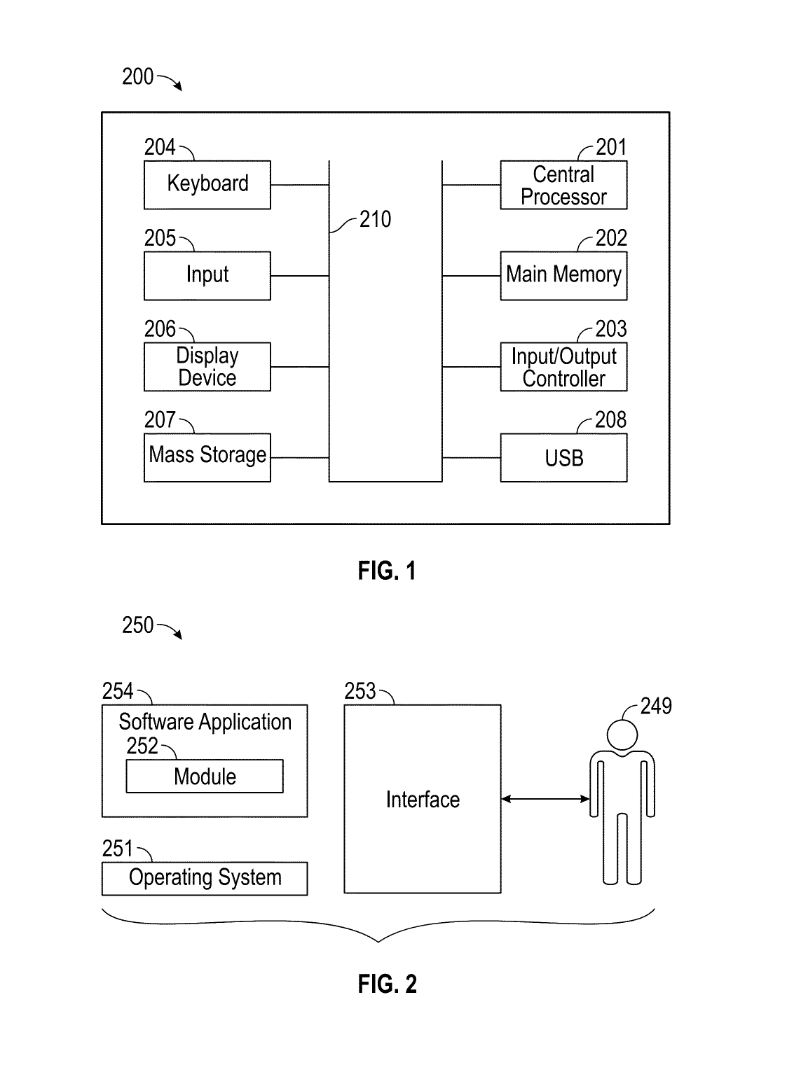

FIGS. 1-2 are provided as exemplary diagrams of data-processing environments in which embodiments may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, some embodiments may be implemented in the context of a data-processing system 200 that includes, for example, a central processor 201, a main memory 202, an input/output controller 203, a keyboard 204, an input device 205 (e.g., pointing device, such as a mouse, track ball, pen device and/or a touchscreen, etc.), a display device 206, a mass storage 207 (e.g., a hard disk), and a USB (Universal Serial Bus) peripheral connection 208. As illustrated, the various components of data-processing system 200 can communicate electronically through a system bus 210 or similar architecture. The system bus 210 may be, for example, a subsystem that transfers data between, for example, computer components within data-processing system 200 or to and from other data-processing devices, components, computers, etc.

FIG. 2 illustrates a computer software system 250 for directing the operation of the data-processing system 200 depicted in FIG. 1. Software application 254, stored in main memory 202 and on mass storage 207, generally includes a kernel or operating system 251 and a shell or interface 253. One or more application programs, such as software application 254, may be “loaded” (i.e., transferred from mass storage 207 into the main memory 202) for execution by the data-processing system 200. The data-processing system 200 receives user commands and data through an interface 253; these inputs may then be acted upon by the data-processing system 200 in accordance with instructions from operating system 251 and/or software application 254.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The interface 253, which is preferably a graphical user interface (GUI), also can serve to display results, whereupon a user may supply additional inputs or terminate the session. In one possible embodiment, operating system 251 and interface 253 can be implemented in the context of a “Windows” system. It can be appreciated, of course, that other types of systems are possible. For example, rather than a traditional “Windows” system, other operation systems such as, for example, Linux, Unix, and so forth, may also be employed with respect to operating system 251 and interface 253. The software application 254 can include a module 252 that includes instructions such as, for example, the instructions shown in blocks 82, 84, 86, 88 and the various other steps and operations described herein with respect to various components and modules.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including for example, Macintosh, UNIX, LINUX, and the like and other computing paradigms and programs.

### Interpolation Techniques Applied to the Study of Geophysical Data

Different interpolation techniques can be applied to geophysical data. A spatial analysis was performed, for example, with respect to California earthquakes geological data in different locations, by varying the latitude and longitude. The magnitude of the earthquake can be estimated at any given time. The time (e.g., in one case, the year) can be fixed and based on data collected from different regions. Interpolation models can thus be used including some spline interpolation techniques to estimate the surface of best fit. In order to calculate the accuracy of the interpolation methods that were used on our geophysical data set, the Sum of Squares of Errors (SSE) and Coefficient of Determination (R-square) can be computed, which provide an indication of how well data points fit a statistical model.

The “critical value phenomena” was analyzed, which deals with three modeling techniques for estimating major-events (in this case a major earthquake). In some cases, Ising models can be used. In other cases, a phase transition can be implemented, fitting the data with an exponential sequence and utilizing the so-called scale invariance property. In these approaches, by analyzing the preceding data collected before a major earthquake, models can be employed to estimate parameters leading to such a major crash. This modeling approach can also be used to describe the behavior of a financial market before the crash. Similarly, where a scale invariant technique is generalized and used, a method has been developed based on the generalization of truncated Lévy models where they estimate the first critical event that may surface.

In some embodiments, nonparametric regression methods can be applied to the same geophysical data considered here. Two versions of a nonparametric method can be utilized: (1) Loess and (2) Lowess. A spatial analysis can be performed by using these methods on the same data set in order to predict the intensity of the earthquake in locations that were not used to estimate the regression surface. A prediction surface can be fitted and the earthquake magnitude estimated in a location that was not used to generate the surface. In most cases, the Lowess performed better than its quadratic counterpart. The results were promising and efficient and the approach proved to be robust for estimating future earthquake intensities. As will be discussed in greater detail herein, we can deal with the same data set, but from a different motivation standpoint. In an example embodiment, different complex interpolation techniques can be applied on the same geophysical data set and a best prediction surface and SSE fitted due to different interpolation techniques.

A motivation for applying interpolation methods in order to estimate future earthquakes magnitude at a fixed location (i.e., latitude and longitude are being fixed) is unique and different from previous approaches analyzing similar spatial data. Instead of estimating the major earthquake date (i.e., deal with the time series data), a spatial analysis can be implemented, wherein the time in this case, the year) is fixed, and the earthquake data collected from different locations of a particular geographical region. Based on these data trends, different interpolation methods can be applied to fit a surface by utilizing different interpolation techniques. Such methods and systems, as discussed in greater detail herein, are efficient for dealing with these data sets. Computed parameters of best fit indicate an excellent fit for estimating a surface for most interpolation techniques implemented. A conclusion can be reached that these interpolation techniques are very useful for analyzing spatial data in order to predict the future magnitude of an earthquake when given the location. Some interpolation techniques are more efficient than others, depending on the situation and the number of data points utilized. Overall, the methods are very simple to understand and apply. The results in terms of the surface of best fit given any data set are very accurate and promising.

As will be discussed shortly, the source of geophysical data is explained including the motivation for dealing with such data. Additionally, mathematical descriptions of the different interpolation techniques utilized are also explained. The results of utilizing techniques or a numerical experimentation with the data set are also explained. Finally, conclusions will be discussed regarding the suitability of the disclosed techniques applied to the data set.

In an example embodiment, geophysical data sourced from the U.S. Geological Survey (USGS) from 1^{st} January 1973 to 9^{th} November 2010 can be utilized. In this example, such data contains information regarding the date, longitude, latitude, and magnitude of each recorded earthquake in a particular region. The location of the major earthquake selected defines the area studied. This area should not be too small (i.e., lack of data) or too big (e.g., noise from unrelated events). The data can be obtained utilizing a square centered at the coordinates of the major event. The sides of the square can be usually as, for example, ±0.1°−0.2° in latitude and ±0.2°−0.4° in longitude. A segment 0.1° of latitude at the equator, for example, is ≈11.11 km≈6.9 miles in length.

The earthquake magnitude is the recorded data used in the analysis. The policy of the USGS regarding recorded magnitude is the following:
(i) Magnitude is a dimensionless number between 1-12.
(ii) The reported magnitude should be a moment magnitude, if available.
(iii) The least complicated, and probably most accurate terminology is simply to utilize the term “magnitude”.

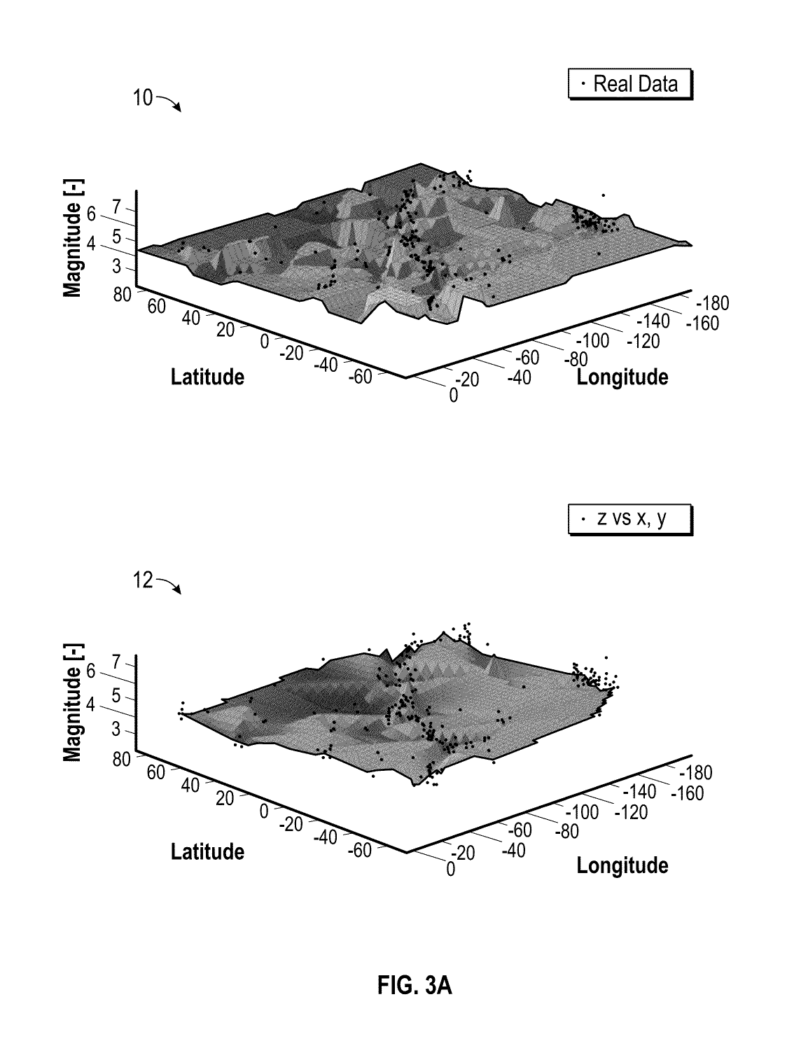

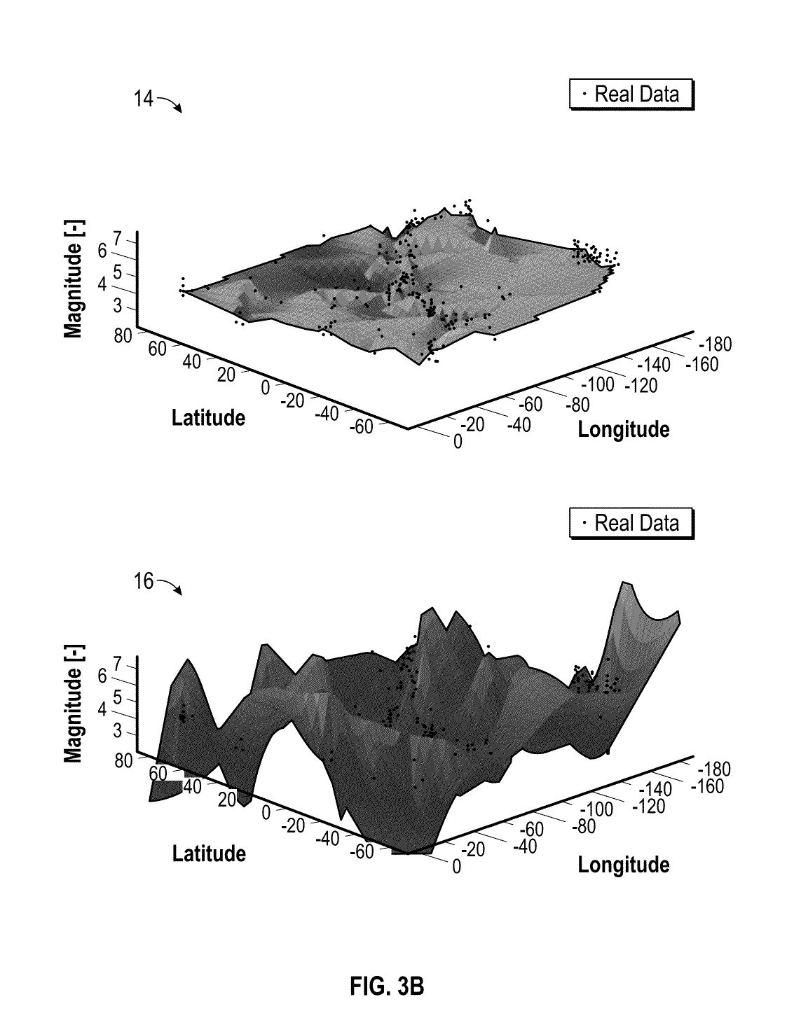

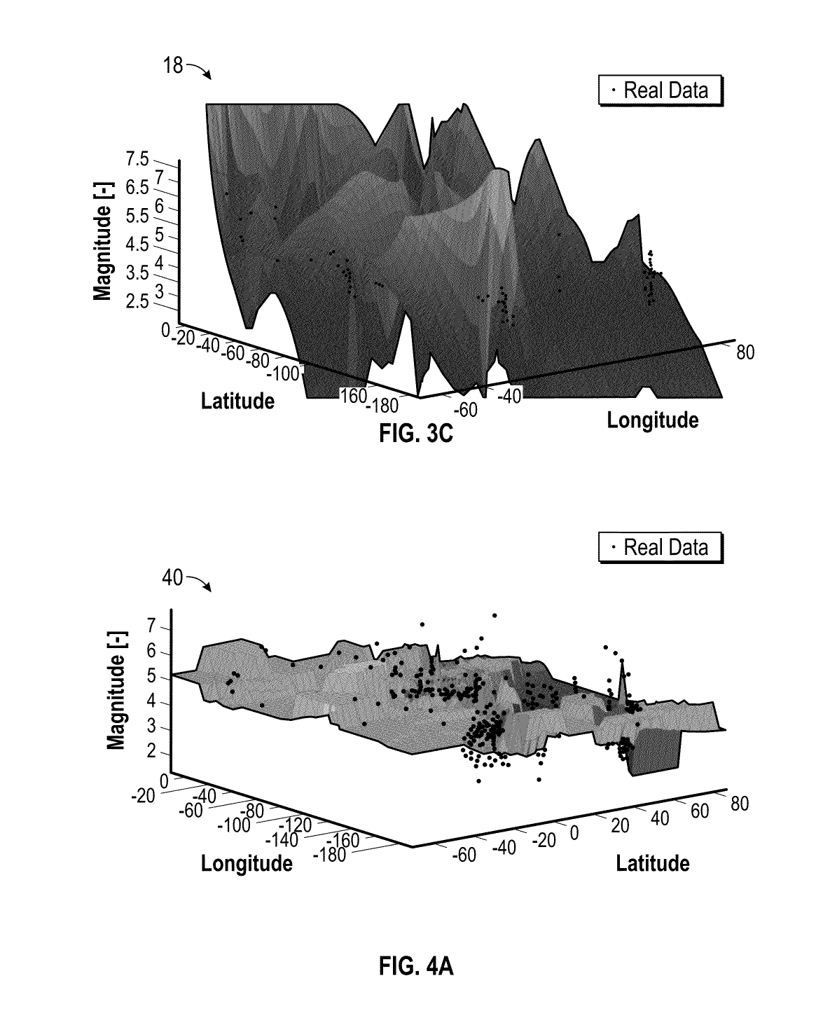

FIGS. 3A, 3B, and 3C illustrate a group of graphs 10, 12, 14, 16, 18 depicting data indicative of simulation results for the earthquake that occurred in the months of January-April in 1973, in accordance with an example embodiment. For all such simulations shown in FIGS. 3A, 3B, and 3C, 653 data points were utilized, which contain the magnitude of the earthquake collected from different locations. An interpolant estimation surface is generated by the following: (a) nearest neighborhood method (see graph 10); (b) bilinear method (see graph 12); (c) bicubic method (see graph 14); (d) biharmonic method (see graph 16); and (e) thin-plate spline (see graph 18). Graphs 10 and 12 are shown in FIG. 3A and respectively labeled “Real Data” and “z vs x,y”. Graphs 14 and 16 are shown in FIG. 3B and are both labeled “Real Data”. Graph 18 is shown FIG. 3C and is also labeled with “Real Data”.

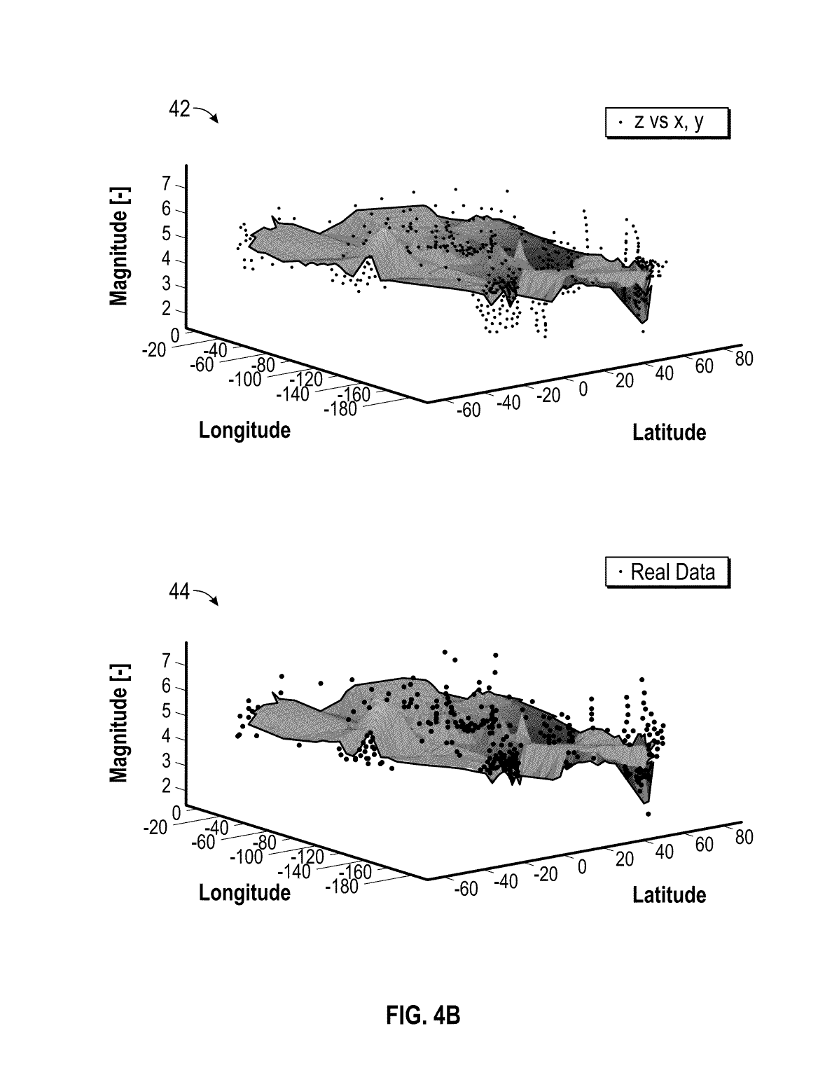

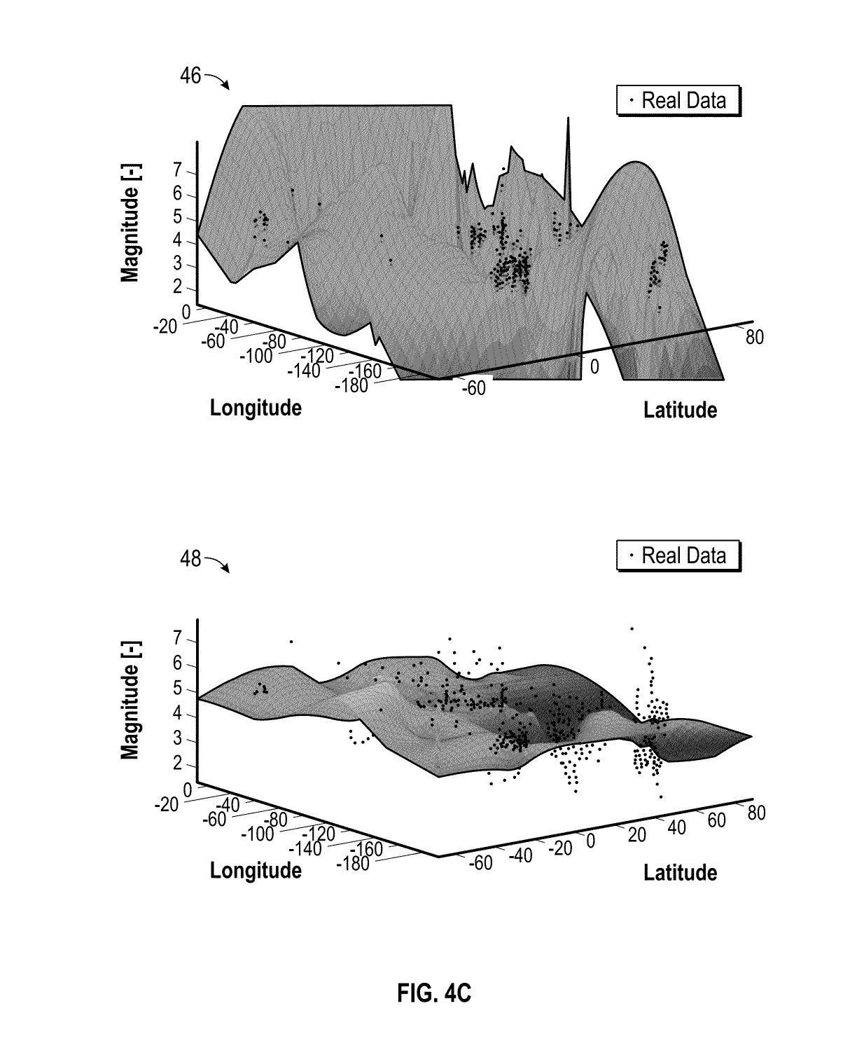

FIGS. 4A, 4B, and 4C illustrate a group of graphs 40, 42, 44, 46, 48 depicting data indicative of simulation results for an earthquake that occurred in the months of January-May of 1979, in accordance with an example embodiment. For all the simulations, 1139 data points were used, which contain the magnitude of the earthquake collected from different locations. The interpolant estimation surface is generated by the following: (a) nearest neighborhood method (see graph 40); (b) linear method (see graph 42); (c) cubic method (see graph 44); (d) biharmonic method (see graph 46); and (e) thin-plate spline (see graph 48). Graphs 18 and 40 are shown in FIG. 4A and are both labeled with “Real Data” Graphs 42 and 44 are shown in FIG. 4B and are respectively labeled “z vs x, y” and “Real Data”. Graphs 46 and 48 are shown in FIG. 4C and are both labeled “Real Data”.

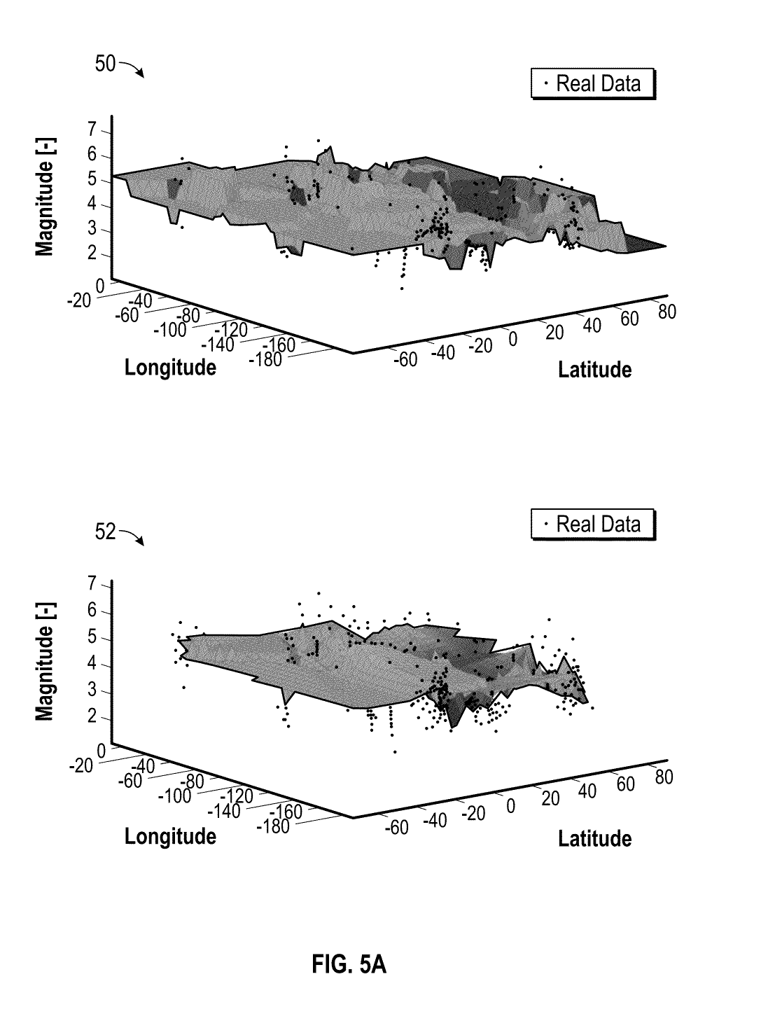

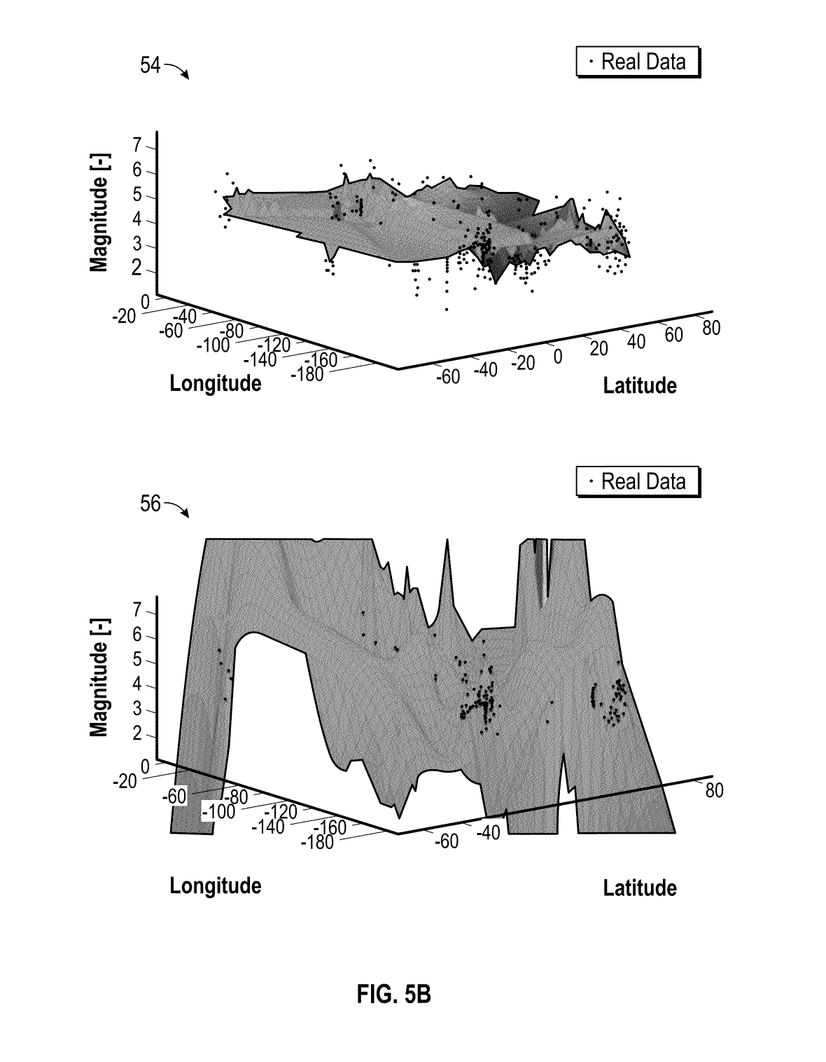

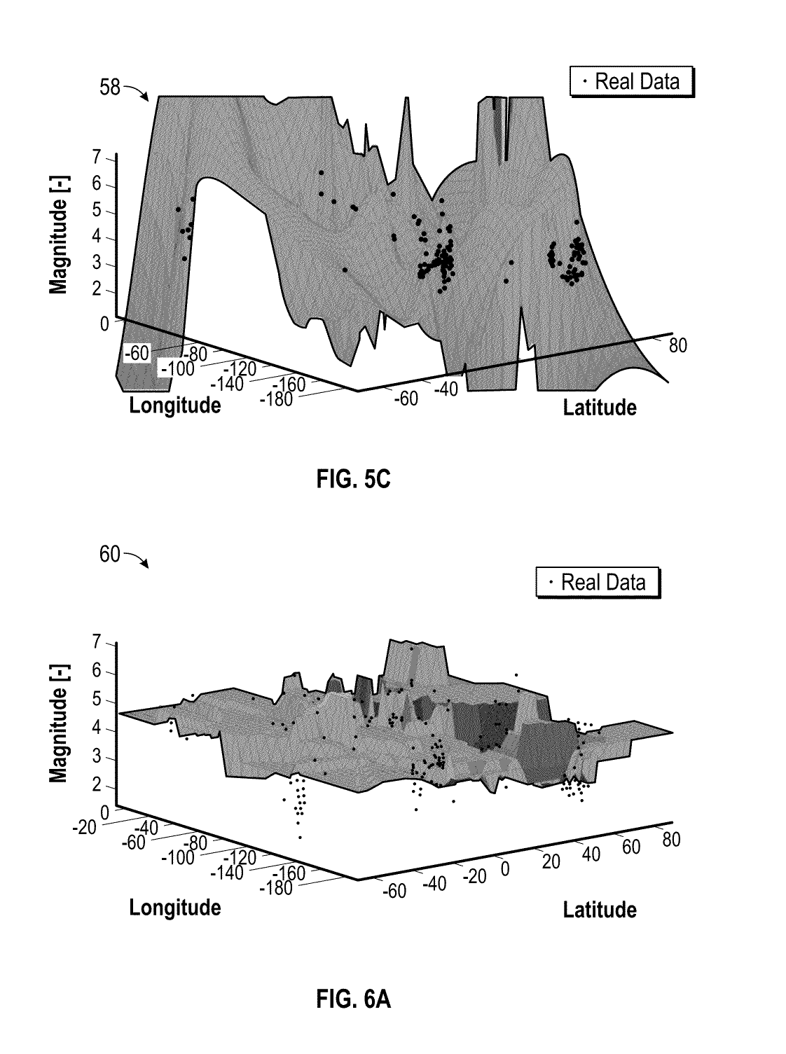

FIGS. 5A, 5B, and 5C illustrate a group of graphs 50, 52, 54, 56, 58 depicting data indicative of simulation results for an earthquake that occurred in the months of April-June of 1988 in accordance with an example embodiment. For all the simulations, 700 data points were used, which contain the magnitude of the earthquake collected from different locations. The interpolant estimation surface is generated by the following: (a) nearest neighborhood method (see graph 50); (b) bilinear method (see graph 52); (c) bicubic method (see graph 54); (d) biharmonic method (see graph 56); and (e) thin-plate spline (see graph 58). Graphs 50 and 52 are shown in FIG. 5A and are both labeled as “Real Data”. Graphs 54 and 56 are shown in FIG. 5B and are both labeled as “Real Data”. Graph 58 is shown in 5C and is also labeled with “Real Data”.

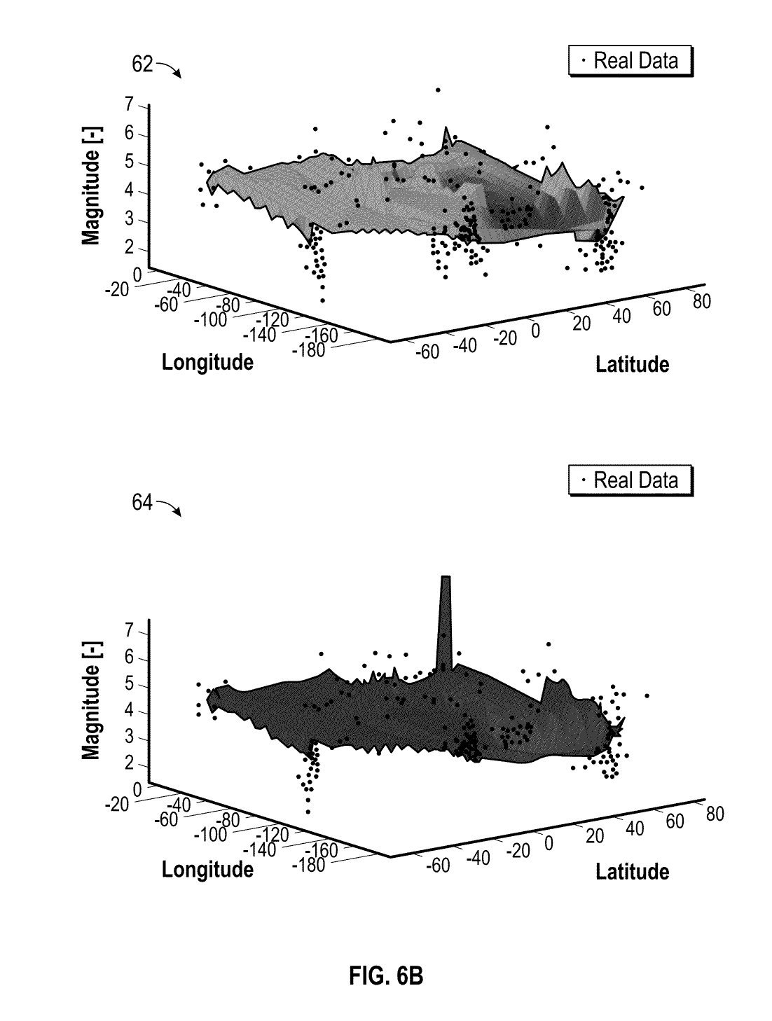

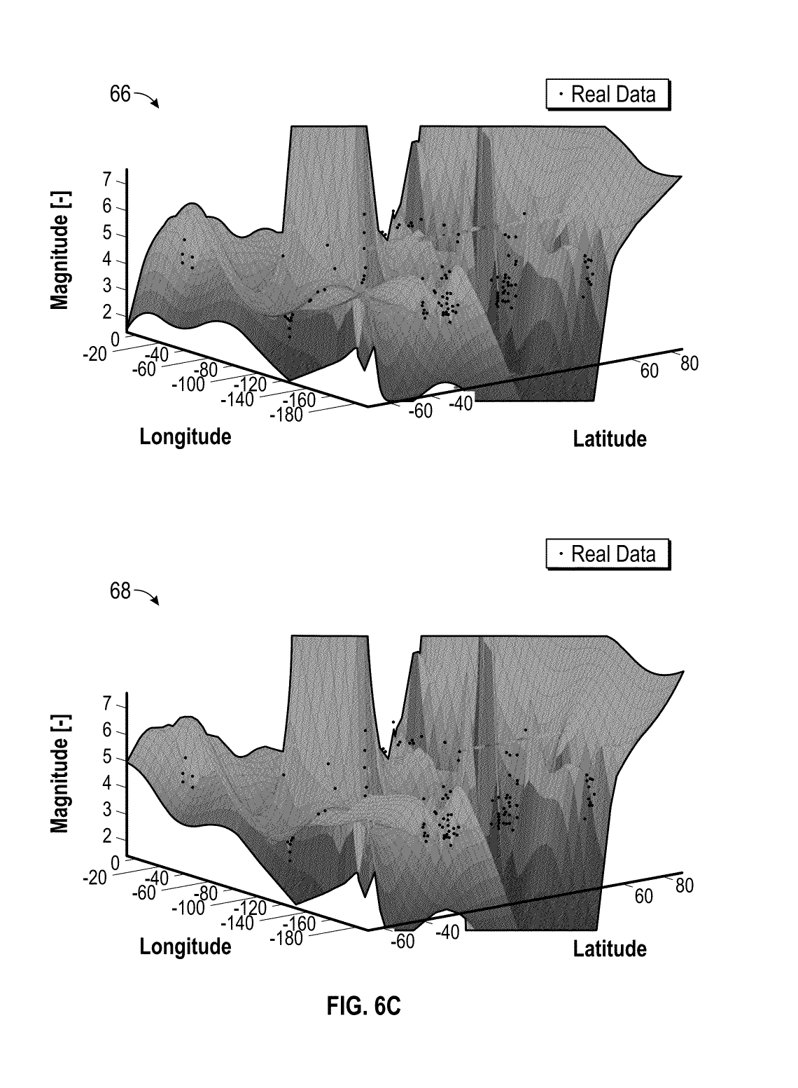

FIGS. 6A, 6B, and 6C illustrate a group of graphs 60, 62, 64, 66, 68 depicting data indicative of simulation results for an earthquake that occurred in the months of September-October of 1996, in accordance with an example embodiment. For all the simulations, 560 data points were used, which contains the magnitude of the earthquake data collected from different locations. The interpolant estimation surface can be generated by the following: (a) nearest neighborhood method (see graph 60); (b) bilinear method (see graph 62); (c) bicubic method (see graph 64); (d) biharmonic method (see graph 66); and (e) thin-plate spline (see graph 68). Graphs 60 is shown in FIG. 6A and is labeled with “Real Data”. Graphs 62 and 64 are shown in FIG. 6B and are both labeled with “Real Data”. Graphs 66 and 68 are shown in FIG. 6C and are also both labeled as “Real Data”.

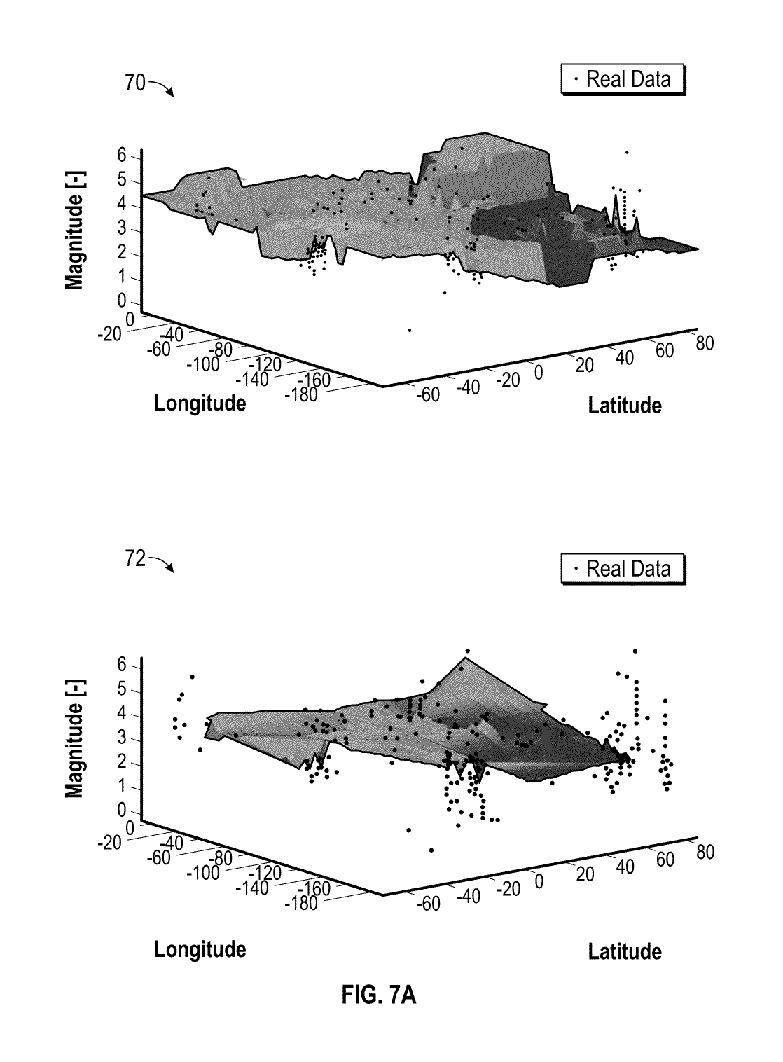

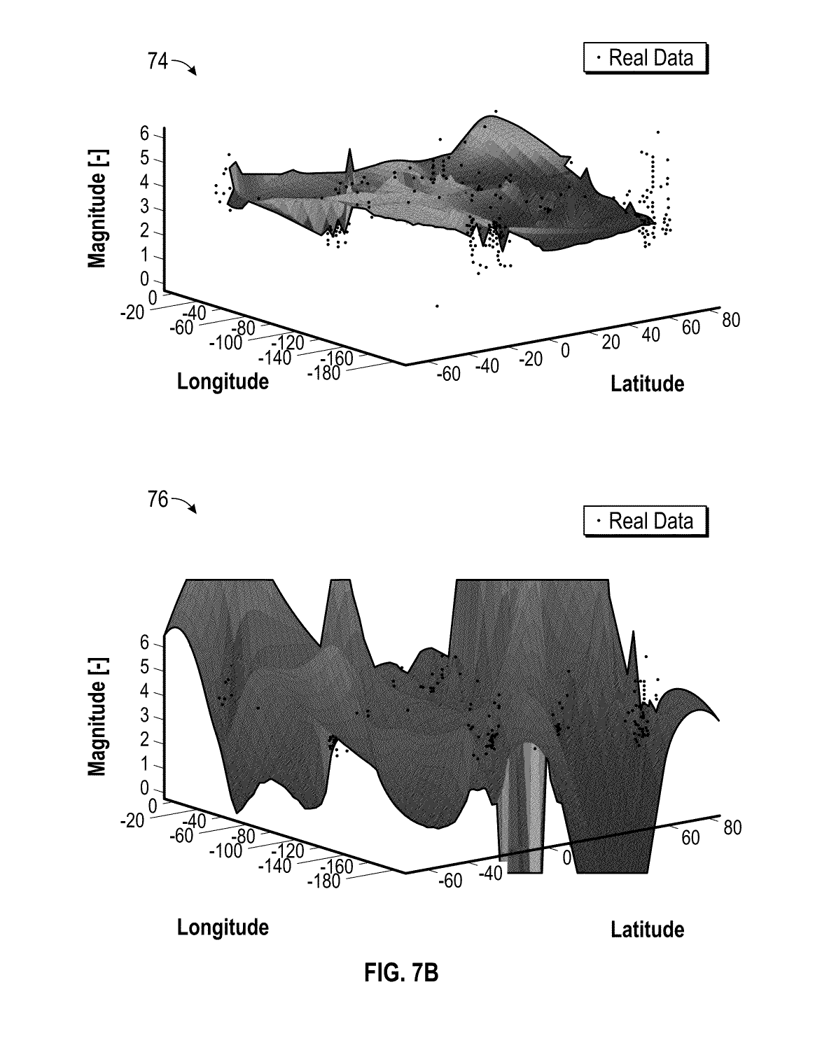

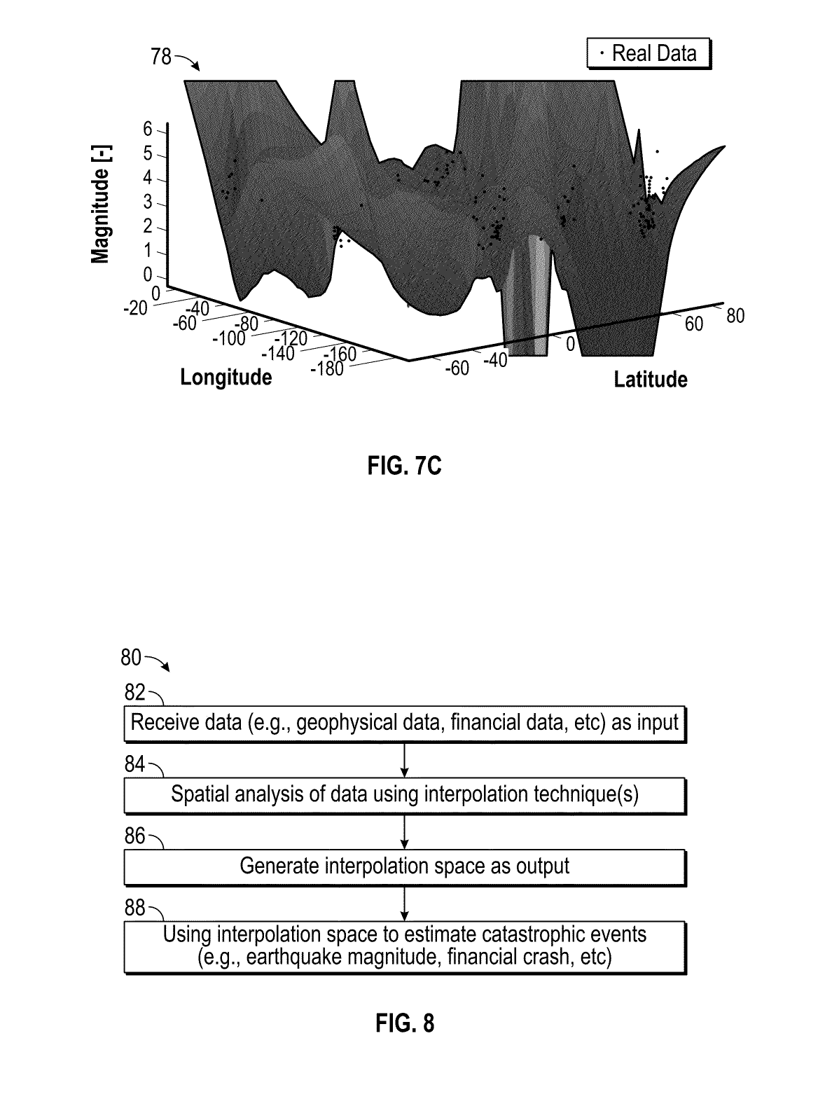

FIGS. 7A, 7B, and 70 illustrate a group of graphs 70, 72, 74, 76, 78 depicting data indicative of simulations results for the earthquake that occurred during the months of November-December of 2008, in accordance with an example embodiment. The interpolant method surface in this example was generated by: (a) nearest neighborhood method (see graph 70); (b) bilinear method (see graph 72); (c) bicubic method (see graph 74); and (d) biharmonic method (see graphs 76 and 78). Graphs 70 and 72 are shown in FIG. 7A and are both labeled with “Real Data”. Graphs 74 and 76 are shown in FIG. 7B and are also both labeled as “Real Data”. Graph 78 is shown in 7C and is also labeled with “Real Data”.

In a numerical study, data collected from different locations at a given time was used to estimate the magnitude of the earthquake at a given location, where the real magnitude is known. The magnitude can be recorded in the data that was used, and where available, the moment magnitude can also be utilized.

In numerical analysis, interpolation is a process for estimating values that lie within the range of a known discrete set of data points. In engineering and science, one often has a number of data points, obtained by sampling or experimentation, which represent the values of a function for a limited number of values of the independent variable. It is often required to interpolate (i.e., estimate) the function at an intermediate value of the independent variable. This may be achieved by curve fitting or regression analysis.

Another similar problem is to approximate complicated functions by using simple functions. Suppose we know a formula to evaluate a function, but it's too complex to calculate at a given data point. A few known data points from the original function can be used to create an interpolation based on a simpler function. Of course, when a simple function is used to estimate data points from the original, interpolation errors are usually present; however, depending on the problem domain and the interpolation method that was used, the gain in simplicity may be of greater value than the resultant loss in accuracy. There is another kind of interpolation in mathematics referred to as “interpolation of operators”.

As will be discussed herein, five simple interpolation models were implemented in an experimental embodiment to study the geophysical data set that lists the magnitude of earthquake intensities in different California regions. Below, a brief description of the interpolation methods is provided.

Nearest-neighbor interpolation (also known as proximal interpolation) is a simple method of multivariate interpolation in one or more dimensions. The nearest neighbor algorithm selects the value of the nearest point and does not consider the values of neighboring points at all, yielding a piecewise-constant interpolant. The algorithm is very simple to implement and is commonly used (usually along with mipmapping) in real-time 3D rendering to select color values for a textured surface.

Bilinear interpolation is a special technique which is an extension of regular linear interpolation for interpolation functions of two variables (i.e., x and y) on a regular 20 grid. The main idea is to perform linear interpolation first in one direction, and then again in the other direction. Although each step is linear in the sampled values and in the position, the interpolation as a whole is not linear, but rather quadratic in the sample location. Bilinear interpolation is a continuous fast method where one needs to perform only two operations: one multiply and one divide; while bounds are fixed at extremes.

Suppose that we want to find the value of the unknown function f at the point P=(x, y). It is assumed that we know the value of f at the four points Q₁₁=(x₁, y₁), Q₁₂=(x₁, y₂), Q₂₁=(x₂, y₁), and Q₂₂=(x₂, y₂). We first do linear interpolation in the x-direction.

This yields:

$$f ( {R}_{1} ) \approx \frac{{x}_{2} - x}{{x}_{2} - {x}_{1}} f ( {Q}_{11} ) + \frac{x - {x}_{1}}{{x}_{2} - {x}_{1}} f ( {Q}_{21} )$$

where R₁=(x,y₁),

$$f ( {R}_{2} ) \approx \frac{{x}_{2} - x}{{x}_{2} - {x}_{1}} f ( {Q}_{12} ) + \frac{x - {x}_{1}}{{x}_{2} - {x}_{1}} f ( {Q}_{22} )$$

where R₂=(x,y₂).
We next proceed by interpolating in the y-direction:

$$f ( P ) \approx \frac{{y}_{2} - y}{{y}_{2} - {y}_{1}} f ( {R}_{1} ) + \frac{y - {y}_{1}}{{y}_{2} - {y}_{1}} f ( {R}_{2} )$$

This follows the desired estimate of f(x,y).

$$f ( x , y ) \approx \frac{f ( {Q}_{11} )}{( {x}_{2} - {x}_{1} ) ( {y}_{2} - {y}_{1} )} ( {x}_{2} - x ) ( {y}_{2} - y ) + \frac{f ( {Q}_{21} )}{( {x}_{2} - {x}_{1} ) ( {y}_{2} - {y}_{1} )} ( x - {x}_{1} ) ( {y}_{2} - y ) + \frac{f ( {Q}_{12} )}{( {x}_{2} - {x}_{1} ) ( {y}_{2} - {y}_{1} )} ( {x}_{2} - x ) ( y - {y}_{1} ) + \frac{f ( {Q}_{22} )}{( {x}_{2} - {x}_{1} ) ( {y}_{2} - {y}_{1} )} ( x - {x}_{1} ) ( y - {y}_{1} )$$

$$f ( x ) = \frac{1}{( {x}_{2} - {x}_{1} ) ( {y}_{2} - {y}_{1} )} ( f ( {Q}_{11} ) ( {x}_{2} - x ) ( {y}_{2} - y ) + f ( {Q}_{21} ) ( x - {x}_{1} ) ( {y}_{2} - y ) + f ( {Q}_{12} ) ( {x}_{2} - x ) ( y - {y}_{1} ) + f ( {Q}_{22} ) ( x - {x}_{1} ) ( y - {y}_{1} ) )$$

Note that the same result can be achieved by executing the y-interpolation first and the x-interpolation second.

If we select the four points where f is given to be (0,0), (1,0), (0,1), and (1,1) as the unit square vertices, then the interpolation formula simplifies to:

ƒ(x,y)≈ƒ(0,0)(1−x)(1−y)+ƒ(1,0)x(1−y)+ƒ(0,1)(1−x)y+ƒ(1,1)xy

Contrary to what the name suggests, the bilinear interpolant is not linear; nor is it the product of two linear functions. In other words, the interpolant can be written as

b₁+b₂x+b₃y+b₄xy

The number of constants (e.g., four) correspond to the number data points where f is given. The interpolant is linear along parallel lines to either the x or the y direction, equivalently if x or y is set constant. Along any other straight line, the interpolant is quadratic. However, even if the interpolation is not linear in the position (x and y), it is linear in the amplitude, as it is apparent from the equations above: all the coefficients bⱼ, j=1 . . . 4, are proportional to the value of the function f.

The result of bilinear interpolation is independent of which axis is interpolated first and which second. If we had first performed the linear interpolation in the y-direction and then in the x-direction, the resulting approximation would be the same. The extension of bilinear interpolation to three dimensions is referred to as trilinear interpolation. This process needs no arithmetic operations and is very fast. It has discontinuities at each value and its bounds are fixed at extreme points.

Bicubic interpolation is an extension of cubic interpolation for interpolating data points on a two dimensional regular grid. The interpolated surface is smoother than

TABLE 1
Goodness of fit parameters for the data of the year 1973

| Method | Sum of Squares of Error (SSE) | R-square |
|---|---|---|
| Nearest-neighbor | 0.31 | 0.999 |
| Bilinear | 0.31 | 0.999 |
| Bicubic | 0.31 | 0.999 |
| Biharmonic | 0.31 | 0.999 |
| Thin-plate Spline | 0.31 | 0.999 |

corresponding surfaces obtained by bilinear interpolation or nearest-neighbor interpolation. Bicubic interpolation can be accomplished by using either Lagrange polynomials, cubic splines, or cubic convolution algorithms.

Suppose that the function values f and the derivatives of fₓ,f_{y} and f_{xy} are known at the four corners (0,0), (1,0), (0,1), and (1,1) of the unit square. The interpolated surface can be then written as:

$$p ( x , y ) = {\sum }_{i = 0}^{3} {\sum }_{j = 0}^{3} {a}_{ij} {x}^{i} {y}^{j}$$

The interpolation problem thus involves determining the 16 coefficients of aᵢⱼ.

Matching p(x,y) with the function values yields four equations, as follows:

$$f ( 0 , 0 ) = p ( 0 , 0 ) = {a}_{00}$$

$$f ( 1 , 0 ) = p ( 1 , 0 ) = {a}_{00} + {a}_{10} + {a}_{20} + {a}_{30}$$

$$f ( 0 , 1 ) = p ( 0 , 1 ) = {a}_{00} + {a}_{01} + {a}_{02} + {a}_{03}$$

$$f ( 1 , 1 ) = p ( 1 , 1 ) = {\sum }_{i = 0}^{3} {\sum }_{j = 0}^{3} {a}_{ij}$$

All the directional coefficients can be determined by the following identities:

$${f}_{x} ( x , y ) = {p}_{x} ( x , y ) = {\sum }_{i = 1}^{3} {\sum }_{j = 0}^{3} {a}_{ij} i {x}^{i - 1} {y}^{j}$$

$${f}_{y} ( x , y ) = {p}_{y} ( x , y ) = {\sum }_{i = 0}^{3} {\sum }_{j = 1}^{3} {a}_{ij} j {xy}^{j - 1}$$

$${f}_{xy} ( x , y ) = {p}_{xy} ( x , y ) = {\sum }_{i = 1}^{3} {\sum }_{j = 1}^{3} {a}_{ij} ij {x}^{i - 1} {y}^{j - 1}$$

This procedures yields a surface p(x,y) on the unit square [0,1]×[0,1] which is continuous and with continuous derivatives. Bicubic interpolation on an arbitrarily sized regular grid can then be accomplished by patching together such bicubic surfaces, ensuring that the derivatives match on the boundaries. If the derivatives are unknown, they are typically approximated from the function values at points neighboring the corners of the unit square (e.g., by using finite differences). The unknowns in the coefficients aᵢⱼ can be easily determined by solving a linear equation.

TABLE 2
Goodness of fit parameters for the data of the year 1979

| Method | Sum of Squares of Error (SSE) | R-square |
|---|---|---|
| Nearest-neighbor | 14.14 | 0.9825 |
| Bilinear | 14.14 | 0.9825 |
| Bicubic | 14.14 | 0.9825 |
| Biharmonic | 14.14 | 0.9825 |
| Thin-plate Spline | 251 | 0.6897 |

Polynomial splines in R³ are functions given by the following equation:

$$S ( x ) = p ( x ) + {\sum }_{i = 1}^{N} {d}_{i} {\vert x - {x}_{i} \vert}^{2 v - 1} \qquad ( 1 )$$

with v a positive integer and p a polynomial of degree at most equal to v. One reason for the name of ‘polyharmonic spline’ is that |x|^{2v-1} is a multiple of the fundamental solution Φ to the distributed equation:

Δ^{v+1}Φ=δ₀

where the Laplacian is denoted by Δ and δ₀ is the Dirac measure at the origin. The main advantage of using polyharmonic splines is their smoothing interpolation property. Focusing on the R³ case, given a set of distinct points {xᵢ}ₜ₌₁^{N}∈R³ unisolvent for πᵥ³, and corresponding functional values for ƒᵢ ∈R, there is a unique (v+1)—harmonic splines S of the form (1) satisfying the interpolation conditions

S(xᵢ)=ƒᵢ, i=1,2, . . . N

and the side conditions

$${\sum }_{i = 1}^{N} {d}_{i} q ( {x}_{i} ) = 0 , \text{∀} q ∈ {π}_{v}^{3}$$

Biharmonic is a special case for v=1 in equation (1).

Thin plate splines (TPS) are an interpolation and smoothing technique, the generalization of splines so that they may be used with two or more dimensions. The name “thin plate spline” refers to a physical analogy involving the bending of a thin metal sheet; just as the metal has ridgidity, the TPS fit resists bending also, implying a penalty involving the smoothness of the fitted surface. In the physical setting, the deflection is in the z direction, orthogonal to the plane. In order to apply this idea to the problem of coordinate transformation, one interprets the lifting of the plate as a displacement of the x or y coordinates within the plane. In 2D cases, given a set of K corresponding points, the TPS warp is described by 2(K+3) parameters which include 6 global affine motion parameters and 2K coefficients for correspondence of the control points. These parameters are computed by solving a linear system, in other words, TPS has a closed-form solution.

The TPS arises on the square of the second derivative integral, which forms its smoothness measure. In the case where x is two dimensional, for interpolation, the TPS fits a mapping function f(x) between corresponding point-sets yᵢ and xᵢ that minimizes the following energy function:

$$E = {\int }_{ }^{ } {\int }_{ }^{ } [ {( \frac{{δ}^{2} f}{δ {x}_{1}^{2}} )}^{2} + 2 ( \frac{{δ}^{2} f}{δ {x}_{1} δ {x}_{2}} ) + {( \frac{{δ}^{2} f}{δ {x}_{2}^{2}} )}^{2} ] d {x}_{1} d {x}_{2}$$

The smoothing variant, correspondingly, uses a tuning parameter λ to control how non-rigid is allowed for the deformation, balancing the aforementioned criterion with the measure of goodness to fit, thus minimizing:

$${E}_{TPS} ( f ) = {\sum }_{i = 1}^{K} {‖ {y}_{i} - f ( {x}_{i} ) ‖}^{2} + λ {\int }_{ }^{ } {\int }_{ }^{ } [ {( \frac{{δ}^{2} f}{δ {x}_{1}^{2}} )}^{2} + 2 ( \frac{{δ}^{2} f}{δ {x}_{1} δ {x}_{2}} ) + {( \frac{{δ}^{2} f}{δ {x}_{2}^{2}} )}^{2} ] d {x}_{1} d {x}_{2}$$

For this variational problem, it can be shown that there exists a unique minimizer f. The finite element discretization for this variational problem is the method of elastic maps that is used for data mining and nonlinear dimensionality reduction.

TABLE 3
Goodness of fit parameters for the data of the year 1988

| Method | Sum of Squares of Error (SSE) | R-square |
|---|---|---|
| Nearest-neighbor | 4.18 | 0.994 |
| Bilinear | 4.2 | 0.993 |
| Bicubic | 4.2 | 0.993 |
| Biharmonic | 4.21 | 0.993 |
| Thin-plate Spline | 4.18 | 0.994 |

TABLE 4
Goodness of fit parameters for the data of the year 1996

| Method | Sum of Squares of Error (SSE) | R-square |
|---|---|---|
| Nearest-neighbor | 0 | 1 |
| Bilinear | 1.059e−25 | 1 |
| Bicubic | 2.078e−27 | 1 |
| Biharmonic | 7.259e−12 | 1 |
| Thin-plate Spline | 1.435e−10 | 1 |

The thin plate spline has a natural representation in terms of radial basis functions. Given a set of control points {wᵢ, i=1, 2, . . . , K}, a radial basis function basically defines a spatial mapping which maps any location of x in space to a new location f(x), represented by:

$$f ( x ) = {\sum }_{i = 1}^{K} {c}_{i} ϕ ( ‖ x - {w}_{i} ‖ )$$

where ∥ ∥ denotes the usual Euclidean norm and {cᵢ} is a set of mapping coefficients. The TPS corresponds to the radial basis kernel φ(r)=r²logr.

Next we study the efficiency and accuracy of the different interpolation techniques above applied to the geophysical data set. We have applied five different interpolation processes to the same data set, moreover, we calculated the parameters for best fit such as SSE and R-square. These parameters indicate how well fitted the surfaces are with respect to the given data set.

In the numerical study of the data set, we used curve fitting toolbox in Matlab to draw all the interpolation surfaces and calculate the parameters of best fit. Results are presented for five randomly selected years where the magnitude for the earthquake in different locations are available.

In FIGS. 3-7, typical results are shown with respect to the earthquake estimation surface simulated by the five interpolation techniques in some areas of California. Data from 1973, 1979, 1988, 1996, and 2008 was utilized for certain range of months. Real value data were utilized to draw the estimation surface. The data for these figures was measured in the western hemisphere (i.e., −180° in longitude). The entire set of earthquakes analyzed (from 1973, 1978, 1988, 1996, and 2008) is presented in Tables 1-5, respectively. Each table lists the parameters of goodness of fit, such as SSE and R-square obtained utilizing different interpolation methods for five separate years. These parameters are an excellent indicator of the quality of the disclosed fitness surface.

TABLE 5
Goodness of fit parameters for the data of the year 2008

| Method | Sum of Squares of Error (SSE) | R-square |
|---|---|---|
| Nearest-neighbor | 0 | 1 |
| Bilinear | 9.263e−26 | 1 |
| Bicubic | 3.253e−28 | 1 |
| Biharmonic | 2.414e−12 | 1 |
| Thin-plate Spline | 3.942e−11 | 1 |

The numerical results obtained by performing the interpolation methods with respect to the geophysical data set indicate that our estimated interpolation surface produces a very good fit for this data set. An evaluation of the “goodness” of fit parameters, such as SSE and R-square, reveals that all data were very accurately and efficiently utilized to generate the interpolating surface. In general, goodness of fits are generally dependent on the number of data points used for the stimation. In most of the cases we obtained a near zero SSE value and a R-square value close to 1, which are considered to be an excellent measure of fit.

Estimating an earthquake magnitude in a particular location (where latitude and longitude are given) is not always easy because of the random nature of the data. In this paper, we introduced a new technique for processing geophysical data. A spatial analysis was done through the application of several interpolation techniques including spline methods. We generated the interpolation surface that can be utilized to estimate the earthquake magnitude for an unknown location on a later date, assuming the earthquake trend will remain the same in that particular location. Moreover, looking at the computed goodness of fit, it seems data can be fitted very smoothly to generate the interpolating surface that can be useful when estimating predict future values.

The numerical results indicate that all the interpolation processes work better locally than globally. Further investigations are needed in order to answer questions regarding how the data size can affect the statistical result. We can conclude that different interpolation techniques can be efficiently used for analyzing spatial data and estimating future values. These interpolation techniques are a new approach for dealing with spatial geophysical data set.

### Interpolating Techniques and Non-Parametric Regression Methods Applied to Geophysical and Financial Data Analysis

In another example embodiment, two deterministics models can be applied to a spatial earthquake data set that lists all the earthquake magnitude in different locations in a certain time period. In yet another example embodiment, a modified version of the same technique can be utilized to analyze financial data in order to find a curve of best fit. Such modeling techniques turn out to be robust and accurate for handling these kinds of data sets and can also be combined with stochastic models.

In some embodiments, numerical simulations can be performed with Lowess/Loess methods referred to earlier herein, applied to geophysical data and also in some cases, high frequency financial data. Lowess and Loess (locally weighted scatterplot smoothing) are two strongly related non-parametric regression methods that include multiple regression models in a k-nearest-based meta model. “Loess” is a much generic version of “Lowess”. Its name arises in “LOcal regrESSion”. They are both constructed on the linear and nonlinear least square regression. These methods are more powerful and effective for studies in which the classical regression procedures cannot produce satisfactory results or cannot be efficiently applied without undue labor. Loess incorporates much of the simplicity of the linear least squares regression with some room for nonlinear regression. It works by fitting simple models to localized subsets of the data in order to construct a function that describes pointwise the deterministic part of the variation of data. The main advantage of this method is that we need no data analyst to determine a global function of any form to fit a model to the entire data set, only to the segment of data.

This method involves a great deal of increased computation as it is a computationally intense procedure. In a modern computational set up, Lowess/Loess has been designed to take the advantage of current computational ability to fullest advantage in order to achieve goals not easily achieved by traditional methods. A smooth curve through a set of data points obtained with an statistical technique is called a Loess curve, particularly when smoothed value is obtained by a weighted quadratic least squares regression over the span of values of the y-axis scattergram criterion variable. Similarly, the same process is referred to as a Lowess curve when each smoothed valued is given by weighted linear least squares regression over the span, although some literature presents Lowess and Loess as synonymous. Some key feature of the local regression models are described below.

Lowess/Loess was originally proposed and further improved upon specifically with a method that is also known as locally weighted polynomial regression. At each point in the data set, a low-degree polynomial is fitted to a subset of the data with explanatory variable values near the point whose response is being estimated. A weighted least square method can be implemented in order to fit the polynomial where more weightage is given to the points near the point whose response is being estimated and less importance to the points further away. The value of the regression function for the point is then evaluated by calculating the local polynomial using the explanatory variable values for that data point. One needs to compute the regression function values for each of the n data points in order to complete the Lowess/Loess processes. Many of the details of these methods, such as degree of the polynomial model and weights, are flexible.

The subset of data used for each weighted least square fit in Lowess/Loess are decided by a nearest neighbor's algorithm. One can predetermine a specific input for the process referred to as the “bandwidth” or “smoothing parameter”, which determines how much of the data is utilized to fit each local polynomial according to the need. The smoothing parameter α, is restricted between the value

$$\frac{( λ + 1 )}{n}$$

and 1, with λ denoting the degree of the local polynomial. The value of α is the proportion of data used in each fit. The subset of data used in each weighted least squares fit comprises the nα points (rounded to the next larger integer) whose explanatory variable values are closest to the point at which the response is being evaluated.

The smoothing parameter α is named because it controls the flexibility of the Lowess/Loess regression function. Large values of a produce the smoothest functions that wiggle the least in response to fluctuations in the data. The smaller α is, the closer the regression function will conform to the data, but using a very small value for the smoothing parameter is not desirable because the regression function will eventually begin to capture the random error in the data. For the majority of Lowess/Loess applications, α values can be selected in a range of 0.25 to 0.5. First and second degree polynomials can be utilized to file local polynomials to each subset of data. This means, either a locally linear or quadratic function is most useful. Using a zero polynomial turns Lowess/Loess into a weighted moving average. Such a simple model may work well for some situations, and may approximate the underlying functions well enough. High-degree polynomials work great in theory, but the Lowess/Loess methods are based on the idea that any function can be approximated in a small neighborhood by a low-degree polynomial and simple models can be fit to data easily. High-degree polynomials tend to overfit data in each subset and are numerically unstable, making precise calculations almost impossible.

As mentioned above, Lowess/Loess methods use traditional tri-cubed weight functions. However, any other weight function that satisfies certain properties can be taken into consideration. That is, the process of calculating the weight for a specific point in any localized subset of data can be accomplished by evaluating the weight function at the distance between the point and the point of estimation, after scaling the distance so that the maximum absolute distance over all possible points in the subset of data, is exactly one.

The biggest advantage that the Lowess/Loess methods have over many other methods is the fact that they do not require the specification of a function to fit a model over the sampled global data. Instead, an analyst has to provide a smoothing parameter value and the degree of the local polynomial. Moreover, the flexibility of this process makes it ideal for modeling complex processes for which no theoretical model exists. Also, the simplicity to execute the methods make these processes very popular among the modern era regression methods that fit the general framework of least squares regression, but having a complex deterministic structure. Although they are less obvious than some of the other methods related to linear least squares regression, Lowess/Loess also enjoy most of the benefits generally shared by the other methods, the most important of those is the theory for computing uncertainties for prediction, estimation, and calibration.

Many other tests and processes used for validation of least square models can also be extended to Lowess/Loess. The major drawback of Lowess/Loess is the inefficient use of data compared to other least square methods. Typically they require fairly large, densely sampled data sets in order to create good models, the reason behind is that the Lowess/Loess relies on the local data structure when performing the local fitting, thus proving less complex data analysis in exchange of increased computational cost. The Lowess/Loess methods do not produce a regression function that is represented by a mathematical formula, which may be a disadvantage. At times it can make really difficult to transfer the results of an analysis to other researchers; in order to transfer the regression function to others, they would need the data set and the code for the Lowess/Loess calculations. In non-linear regression, on the other hand, it is only necessary to write down a functional form in order to provide estimates of the unknown parameters and the estimated uncertainty.

On the basis of the application, this could be either a major or a minor setback of using Lowess/Loess. In particular, the simple form of Lowess/Loess cannot be applied for mechanistic modeling where fitted parameters specify particular physical properties of the system. Finally, it is worth mentioning the computation cost associated with this procedure, although this should not be a problem in the modern computing environment unless the data sets being used are very large. Lowess/Loess methods also have a tendency to be affected by the outliers in the data set, like any other least square methods.

There is an iterative robust version of Lowess/Loess that can be applied to reduce sensitivity to outliers, but if there are too many extreme outliers, this robust version also fails to produce the desired results. Analyzing earthquake data sets is not always a very easy modeling procedure, as many different factors can be involved in these phenomena. If we analyze the time series data in order to estimate parameters corresponding to some extreme earthquakes, the modeling technique has to be dependent on traditional stochastic procedure. As we performed spatial analysis of the data with a freezing time, the deterministic behavior can be taken into account. We observe that the results were more dependent on the nature of the data and how the different locations (where the magnitude of the earthquake is given) are close to each other, if we consider data for locations that are sparsely located then the local regression model will not work up to our satisfaction; we have considered the locations that are geographically closer. We conclude that somehow Lowess has been proved to be a better estimator than the other process. That may be due to some data trends in the data set. Overall, this method has been proven to be a better deal to get numerical estimations for spatial analysis.

The high frequency data arising from financial market were treated with different smoothing techniques and the best curve fitted provided a very good estimation to the data. The robust version of the weighted local regression technique was much more desirable than its original version. The current work shows that these modeling methods may be applied to high frequency data and to individual equity data.

In previous embodiments implemented with these geophysical data sets, Ising type models, Lévy models, and scale invariance properties were used to provide estimations of a “critical phenomena” by using the time series data. With our weighted local regression type model, we fixed the time (in this case the year) and used the magnitude of the earthquake from different locations within the time frame to estimate the magnitude of the earthquake at locations whose data were not used In other words, our model performed a spatial analysis with the given geophysical data. As an extension of this work, we have applied different interpolation methods to the same geophysical data sets and obtained very promising results. Although these are all deterministic models and in general earthquake data are stochastic, we have plans to somehow merge these deterministic models with a strong Lévy's model to see any possible modeling approach that can open a perspective to deal with these data in future. Generally, a Lévy process consists of three essential components, (i) Deterministic part, (ii) Continuous random Brownian part, and (iii) Discontinuous jump part. For spatial analysis using geophysical data, the third part does not play a big role so a modified deterministic approach can be considered an efficient one to deal this phenomenon.

To model high frequency data, we fitted a curve of best fit in the time series data where returns of the stock price were given for every minute for five different financial institutions. Time series modeling (exponential smoothing and ARIMA) is one methodology that can address questions of prediction in financial time series. The aim here, however, is to demonstrate the usefulness of the Local Regression models with some modification applied to such time dependent data set. In literature, there are numerous such fits like the one we presented here, but our fit is very appropriate and efficient to apply for local data. As a matter of fact when stock prices are in general locally influenced, this fit will act as better than many others. Overall, we conclude that our approach is a very powerful and easy to apply method which produces numerical results with excellent efficiency.

The disclosed embodiments can be applied to the estimation of parameters associated to major events in geophysics. This approach can be used to estimate and predict parameters associated to major/extreme events in Econophysics, for example, phase transition. The analogy between phase transition and financial modeling can be easily done when considering the original one-dimensional Ising model in phase transition, this simple model has been used in Physics to describe the ferromagnetism. Isings model considers a lattice composed of N atoms, which interact with their immediate lattice neighbors. Likewise, the financial model will consider a lattice composed of N-traders (each trader can also represent a cluster of traders) which interact in a similar manner. In the model for ferromagnetism, a material evidences a net magnetization below a critical parameter, when all spins were arranged on the same direction. In a similar way, in the model for a market crash, the crash happens when all the traders in the market start to sell.

FIG. 8 illustrates a high-level flow chart of operations illustrating a method 80 for processing data such as geophysical data or financial data, in accordance with an example embodiment. As indicated at block 82, a step or logical operation can be implemented for receiving as input data (e.g., geophysical data such as spatial earthquake data set, financial data, etc.). Thereafter, as illustrated at block 84, a step or operation can be provided for performing spatial analysis with respect to such data by applying a plurality of varying interpolation techniques (e.g.. as discussed herein) to the data. Then, as shown at block 86, a step or operation can be implemented for generating for output an interpolation surface in response to performing the spatial analysis with respect to the data. The interpolation surface is employed for estimating, for example, earthquake magnitude data (i.e., in the case of geophysical data) for a particular location on a later date, assuming an earthquake trend remains constant at the particular location. The interpolation surface can also be implemented for estimating, for example, financial crash data, as discussed earlier herein, as illustrated at block 88.

In the case of earthquake magnitude data, a step or operation can be provided for providing two or more deterministic models from among the interpolation techniques to the spatial earthquake data set to assist in estimating the earthquake magnitude data.

The aforementioned varying interpolation techniques can include, for example, spline interpolation, nearest-neighbor interpolation, bilinear interpolation, bicubic interpolation, and biharmonic interpolation. An example of spline interpolation is thin-plate spline interpolation.

It will be appreciated that variations of the above-disclosed and other features and functions, or alternatives thereof, may be desirably combined into many other different systems or applications. Furthermore, it can be appreciated that various presently unforeseen or unanticipated alternatives, modifications, variations or improvements therein may be subsequently made by those skilled in the art which are also intended to be encompassed by the following claims.

What is claimed is:

1. A method for processing geophysical data, said method comprising:
receiving as input geophysical data;
performing spatial analysis with respect to said geophysical data by applying a plurality of varying interpolation techniques to said geophysical data; and
generating for output an interpolation surface in response to performing said spatial analysis with respect to said geophysical data, wherein said interpolation surface is employed for estimating earthquake magnitude data for a particular location at a later date, assuming an earthquake trend remains constant at said particular location.

2. The method of claim 1 wherein at least one of said plurality of varying interpolation techniques comprises a spline interpolation.

3. The method of claim 1 wherein at least one of said plurality of varying interpolation techniques comprises a nearest-neighbor interpolation.

4. The method of claim 1 wherein at least one of said plurality of varying interpolation techniques comprises a bilinear interpolation.

5. The method of claim 1 wherein at least one of said plurality of varying interpolation techniques comprises a bicubic interpolation.

6. The method of claim 1 wherein at least one of said plurality of varying interpolation techniques comprises a biharmonic interpolation.

7. The method of claim 2 wherein said spline interpolation comprises a thin-plate spline interpolation.

8. The method of claim 1 wherein said geophysical data comprises a spatial earthquake data set.

9. The method of claim 8 further comprising applying at least two deterministic models from among said plurality of varying interpolation techniques to said spatial earthquake data set to assist in estimating said earthquake magnitude data.

10. A system for processing geophysical data, said system comprising:
at least one processor; and
a non-transitory computer-usable medium embodying computer program code, said non-transitory computer-usable medium capable of communicating with said at least one processor, said computer program code comprising instructions executable by said processor and configured for:
receiving as input geophysical data;
performing spatial analysis with respect to said geophysical data by applying a plurality of varying interpolation techniques to said geophysical data; and
generating for output an interpolation surface in response to performing said spatial analysis with respect to said geophysical data, wherein said interpolation surface is employed for estimating earthquake magnitude data for a particular location at a later date, assuming an earthquake trend remains constant at said particular location.

11. The system of claim 10 wherein at least one of said plurality of varying interpolation techniques comprises a spline interpolation.

12. The method of claim 10 wherein at least one of said plurality of varying interpolation techniques comprises a nearest-neighbor interpolation.

13. The method of claim 10 wherein at least one of said plurality of varying interpolation techniques comprises a bilinear interpolation.

14. The method of claim 10 wherein at least one of said plurality of varying interpolation techniques comprises a bicubic interpolation.

15. The method of claim 10 wherein at least one of said plurality of varying interpolation techniques comprises a biharmonic interpolation.

16. The method of claim 11 wherein said spline interpolation comprises a thin-plate spline interpolation.

17. The method of claim 10 wherein said geophysical data comprises a spatial earthquake data set.

18. The method of claim 17 further comprising applying at least two deterministic models from among said plurality of varying interpolation techniques to said spatial earthquake data set to assist in estimating said earthquake magnitude data.

19. A method for processing financial data, said method comprising:
receiving as input a financial data set;
applying at least two deterministic models from among a plurality of varying interpolation techniques to said financial data set to assist in estimating a financial market crash; and
generating for output data indicative of said financial market crash in response to applying said at least two deterministic models to said financial data set.

20. The method of claim 19 wherein at least one of said at least two deterministic models comprises a nonparametric regression model and/or a Lowess/Loess method.
